(19) United States
(12) Patent Application Publication
(10) Pub. No.: US 2016/0319181 A1
(43) Pub. Date: Nov. 3, 2016

(54) CLEAN-UP FLUID FOR WELLBORE PARTICLES CONTAINING AN ENVIRONMENTALLY-FRIENDLY SURFACTANT

(71) Applicant: HALLIBURTON ENERGY SERVICES, INC., Houston, TX (US)

(72) Inventors: Philip D. Nguyen, Houston, TX (US); Loan K. Vo, Houston, TX (US); Michael W. Sanders, Houston, TX (US); Christopher R. Parton, Houston, TX (US)

(21) Appl. No.: 15/104,181

(22) PCT Filed: Feb. 19, 2014
(86) PCT No.: PCT/US2014/017205

§ 371 Date: Jun. 13, 2016

(51) Int. Cl. C09K 8/524; C11D 1/38; C11D 11/00; C11D 3/04

(52) U.S. Cl. CPC C09K 8/524; C11D 3/046; C11D 1/38; C11D 11/0023

(57) ABSTRACT

A method of treating a portion of a well comprising: forming a treatment fluid, wherein the treatment fluid comprises: (A) water; and (B) a surfactant, wherein the surfactant is environmentally-friendly, and wherein the surfactant causes a liquid hydrocarbon to become soluble in the treatment fluid; and introducing the treatment fluid into the well, wherein the treatment fluid comes in contact with wellbore particles after introduction into the well, wherein at least a portion of the wellbore particles are coated with the liquid hydrocarbon prior to contact with the treatment fluid.

### TECHNICAL FIELD

Wellbore particles can become coated with liquid hydrocarbons. The coating can inhibit or prevent a consolidating resin from bonding to the surfaces of the wellbore particles to form a consolidated pack of particles. A clean-up fluid can remove the hydrocarbon coating to clean up the particles and precondition the particles for receiving the resin or other surface coating or reactive material or can be used ahead of an acid stimulation treatment. The clean-up fluid can also be used to remove oil coatings from particles that have been removed from the wellbore. This aspect may be advantageous for disposing of the wellbore particles that have been removed.

### BRIEF DESCRIPTION OF THE FIGURES

The features and advantages of certain embodiments will be more readily appreciated when considered in conjunction with the accompanying figures. The figures are not to be construed as limiting any of the preferred embodiments.

FIGS. 1A-1D are photographs of jars containing a subterranean formation sand that was coated with crude oil and four different treatment fluids. Some of the treatment fluids contained a surfactant.

### DETAILED DESCRIPTION OF THE INVENTION

As used herein, the words “comprise,” “have,” “include,” and all grammatical variations thereof are each intended to have an open, non-limiting meaning that does not exclude additional elements or steps.

As used herein, a “fluid” is a substance having a continuous phase that tends to flow and to conform to the outline of its container when the substance is tested at a temperature of 71° F. (22° C.) and a pressure of 1 atmosphere “atm” (0.1 megapascals “MPa”). A fluid can be a liquid or gas. A homogenous fluid has only one phase; whereas a heterogeneous fluid has more than one distinct phase. A heterogeneous fluid can be: a slurry, which includes a continuous liquid phase and undissolved solid particles as the dispersed phase; an emulsion, which includes a continuous liquid phase and at least one dispersed phase of immiscible liquid droplets; a foam, which includes a continuous liquid phase and a gas as the dispersed phase; or a mist, which includes a continuous gas phase and liquid droplets as the dispersed phase.

Oil and gas hydrocarbons are naturally occurring in some subterranean formations. In the oil and gas industry, a subterranean formation containing oil or gas is referred to as a reservoir. A reservoir may be located under land or off shore. Reservoirs are typically located in the range of a few hundred feet (shallow reservoirs) to a few tens of thousands of feet (ultra-deep reservoirs). In order to produce oil or gas, a wellbore is drilled into a reservoir or adjacent to a reservoir. The oil, gas, or water produced from the wellbore is called a reservoir fluid.

A well can include, without limitation, an oil, gas, or water production well, or an injection well. As used herein, a “well” includes at least one wellbore. A wellbore can include vertical, inclined, and horizontal portions, and it can be straight, curved, or branched. As used herein, the term “wellbore” includes any cased, and any uncased, open-hole portion of the wellbore. A near-wellbore region is the subterranean material and rock of the subterranean formation surrounding the wellbore. As used herein, a “well” also includes the near-wellbore region. The near-wellbore region is generally considered the region within approximately 100 feet radially of the wellbore. As used herein, “into a well” means and includes into any portion of the well, including into the wellbore or into the near-wellbore region via the wellbore.

A portion of a wellbore may be an open hole or cased hole. In an open-hole wellbore portion, a tubing string may be placed into the wellbore. The tubing string allows fluids to be introduced into or flowed from a remote portion of the wellbore. In a cased-hole wellbore portion, a casing is placed into the wellbore that can also contain a tubing string. A wellbore can contain an annulus. Examples of an annulus include, but are not limited to: the space between the wellbore and the outside of a tubing string in an open-hole wellbore; the space between the wellbore and the outside of a casing in a cased-hole wellbore; and the space between the inside of a casing and the outside of a tubing string in a cased-hole wellbore.

During wellbore operations, it is common to introduce a treatment fluid into the well. Examples of common treatment fluids include, but are not limited to, drilling fluids, spacer fluids, completion fluids, and work-over fluids. As used herein, a “treatment fluid” is a fluid designed and prepared to resolve a specific condition of a well or subterranean formation, such as for stimulation, isolation, gravel packing, or control of gas or water coning. The term “treatment fluid” refers to the specific composition of the fluid as it is being introduced into a well. The word “treatment” in the term “treatment fluid” does not necessarily imply any particular action by the fluid.

There are primary and remedial wellbore operations in which it is desirable to consolidate particles together. Examples of particles that are commonly consolidated together to form a consolidated pack of particles are proppant, gravel, and formation particles such as sand and fines.

Proppant is commonly used in conjunction with hydraulic fracturing operations (fracing operations). A fracturing fluid is pumped using a frac pump at a sufficiently high flow rate and high pressure into the wellbore and into the subterranean formation to create or enhance a fracture in the subterranean formation. Creating a fracture means making a new fracture in the formation. Enhancing a fracture means enlarging a pre-existing fracture in the formation. The newly-created or enhanced fracture will tend to close together after pumping of the fracturing fluid has stopped. To prevent the fracture from closing, a material must be placed in the fracture to keep the fracture propped open. A material used for this purpose is often referred to as a “proppant.” The proppant is in the form of solid particles, which can be suspended in the fracturing fluid, carried down hole, and deposited in the fracture as a “proppant pack.” The proppant pack props the fracture in an open position while allowing fluid flow through the permeability of the pack.

Gravel or sand is used in gravel packing operations. Gravel packing can be part of sand control techniques that are used to prevent production of particles from the subterranean formation, such as sand and fines. In gravel pack operations, a steel or alloy sand screen is placed in the wellbore and the surrounding annulus is packed with prepared gravel of a specific size designed to prevent the passage of formation sand into the production tubing string while being restrained by the screen. The primary objective is to stabilize the formation while causing minimal impairment to well productivity. Formation particles can also build up behind the sand screen to form a pack.

If the particles, such as the proppant or gravel are not held in place, then the particles can flow towards the wellhead during production. This undesirable migration can cause damage to wellbore equipment and potentially a loss of integrity, for example to the fracture or wellbore. Therefore, it is often desirable to coat the particles with a resin to form a consolidated pack. The resin can be a tacky resin that acts as a glue to bind the particles of the pack together. The resin can also be a curable resin that cures to become hard and solid via heat and binds the particles of the pack together. The particles of a consolidated pack can then remain in the desired location either temporarily or permanently.

In order for the resin to coat the particles of the pack, it is necessary that the surface of the particles provide a sufficient bonding surface for the resin. However, it is not uncommon for the particles to become coated with liquid hydrocarbons, for example from the subterranean formation. It can be very difficult if not impossible for resins to properly bond to the surface of oil-coated particles. As used herein, the term “oil” is meant to be synonymous with the term liquid hydrocarbons. Moreover, depending on the amount of oil present at the location of the particle pack, the oil can dilute the resin. Therefore, it is often necessary to clean up or precondition the particle pack prior to introducing the resin down hole. Solvents that can dissolve the oil are used to remove the oil from the particles. Once the oil is removed from the surface of the particles, the resin can now bond to the surface.

However, some solvents currently used are not environmentally friendly. For example, glycol ether-based mutual solvents are not environmentally friendly. As such, there is a need for an environmentally-friendly treatment fluid that can clean up and prepare particles of a particle pack to receive a resin for consolidation.

To determine if a chemical is environmentally-friendly, the OSPAR (Oslo/Paris convention for the Protection of the Marine Environment of the North-East Atlantic) Commission has developed a pre-screening scheme for evaluating chemicals used in off-shore drilling. According to OSPAR, a chemical used in off-shore drilling should be substituted with an environmentally-friendly chemical if any of the following are met: a.) it is on the OSPAR LCPA (List of Chemicals for Priority Action); b.) it is on the OSPAR LSPC (List of Substances of Possible Concern); c.) it is on Annex XIV or XVII to REACH (Regulation (EC) No 1907/2006 of the European Parliament and of the Council of 18 Dec. 2006 concerning the Registration, Evaluation, Authorisation and Restriction of Chemicals); d.) it is considered by the authority, to which the application has been made, to be of equivalent concern for the marine environment as the substances covered by the previous sub-paragraphs; e.) it is inorganic and has a LC₅₀ or EC₅₀ less than 1 mg/l; f.) it has an ultimate biodegradation (mineralization) of less than 20% in OECD 306, Marine BODIS or any other accepted marine protocols or less than 20% in 28 days in freshwater (OECD 301 and 310); g.) half-life values derived from simulation tests submitted under REACH (EC 1907/2006) are greater than 60 and 180 days in marine water and sediment respectively (e.g., OECD 308, 309 conducted with marine water and sediment as appropriate); or h.) it meets two of the following three criteria: (i) biodegradation: less than 60% in 28 days (OECD 306 or any other OSPAR-accepted marine protocol), or in the absence of valid results for such tests: less than 60% (OECD 301B, 301C, 301D, 301F, Freshwater BODIS); or less than 70% (OECD 301A, 301E); (ii) bioaccumulation: BCF>100 or log P_{ow}≧3 and molecular weight<700, or if the conclusion of a weight of evidence judgement under Appendix 3 of OSPAR Agreement 2008-5 is negative; or (iii) toxicity: LC₅₀<10 mg/l or EC₅₀<10 mg/l; if toxicity values <10 mg/l are derived from limit tests to fish, actual fish LC₅₀ data should be submitted. As used herein, a chemical is considered to be “environmentally friendly” if any of the above conditions are not satisfied and/or the substance does not cause harm to aquatic life, humans, and mammals.

It has been discovered that environmentally-friendly surfactants can be used to clean up and prepare particles for a consolidation treatment or other surface coating/reactive type treatments, ahead of an acid stimulation treatment, or to clean up coated wellbore particles for disposal. A surfactant is an amphiphilic molecule, comprising a hydrophobic tail group and a hydrophilic head group. The hydrophilic head can be charged. A cationic surfactant includes a positively-charged head. An anionic surfactant includes a negatively-charged head. A zwitterionic surfactant includes both a positively- and negatively-charged head. A surfactant with no charge is called a non-ionic surfactant.

According to an embodiment, a method of treating a portion of a well comprises: forming a treatment fluid, wherein the treatment fluid comprises: (A) water; and (B) a surfactant, wherein the surfactant is environmentally-friendly, and wherein the surfactant causes a liquid hydrocarbon to become soluble in the treatment fluid; and introducing the treatment fluid into the well, wherein the treatment fluid comes in contact with wellbore particles after introduction into the well, wherein at least a portion of the wellbore particles are coated with the liquid hydrocarbon prior to contact with the treatment fluid.

It is to be understood that the discussion of preferred embodiments regarding the treatment fluid or any ingredient in the treatment fluid, is intended to apply to the embodiments. Any reference to the unit “gallons” means U.S. gallons.

The treatment fluid includes water. The treatment fluid can be a homogenous fluid or a heterogeneous fluid. Preferably, the water is the base fluid of the treatment fluid. The treatment fluid can be a heterogeneous fluid, such as a slurry, emulsion, or foam. If the treatment fluid is a heterogeneous fluid, then preferably the water comprises the liquid continuous phase of the heterogeneous fluid, wherein the water is the base fluid. The liquid continuous phase can include dissolved materials and/or undissolved solids. The water can be selected from the group consisting of freshwater, seawater, brine, produced water, and any combination thereof in any proportion. The treatment fluid can further include a water-soluble salt. Preferably, the salt is selected from the group consisting of sodium chloride, calcium chloride, calcium bromide, potassium chloride, potassium bromide, magnesium chloride, and any combination thereof. The treatment fluid can contain the water-soluble salt in a concentration in the range of about 1% to about 35% by weight of the water (bwow).

The treatment fluid includes the surfactant. The surfactant can be an ionic surfactant, nonionic surfactant, or combinations of ionic and nonionic surfactants. The ionic surfactants can be cationic, anionic, zwitterionic, or combinations thereof. The ionic surfactant can be selected from the group consisting of sodium oleate, sodium stearate, sodium dodecylbenzenesulfonate, sodium myristate, sodium laurate, sodium decanoate, sodium caprylate, sodium cetyl sulfate, sodium myristyl sulfate, sodium lauryl sulfate, sodium decyl sulfate, sodium octyl sulfate, derivatives of any of the foregoing, and combinations thereof. The nonionic surfactant can be selected from the group consisting of ethoxylated aliphatic alcohols, nonylphenol ethoxylates (NPEs), octylphenol ethoxylates (OPEs), sulfoxide esters, polyoxyethylene, carboxylic esters, polyethylene glycol esters, anhydrosorbitol ester and ethoxylated derivatives, glycol esters of fatty acids, carboxylic amides, monoalkanolamine condensates, polyoxyethylene fatty acid amides, branched alkylphenol alkoxylates, linear alkylphenol alkoxylates, branched alkyl alkoxylates, derivatives of any of the foregoing, and combinations thereof.

The surfactant is environmentally-friendly. The surfactant can be biocompatible. The surfactant can be stable at the bottomhole temperature of the well. As used herein, the term “bottomhole” means the location of the treatment fluid.

The surfactant causes a liquid hydrocarbon to become soluble in the treatment fluid. As used herein, the term “soluble” means that at least 5 parts of the solute dissolves in 100 parts of the solvent. According to an embodiment, the hydrophobic tail of the surfactant has a carbon chain length such that the liquid hydrocarbon becomes soluble in the treatment fluid. According to another embodiment, the surfactant is selected such that the liquid hydrocarbon becomes soluble in the treatment fluid.

At least a portion of wellbore particles are coated with the liquid hydrocarbon. The wellbore particles can be any particles that are commonly consolidated with a resin or removed from a wellbore. Accordingly, the wellbore particles can be, without limitation, proppant, gravel, subterranean formation sand and/or fines, or combinations thereof. The liquid hydrocarbon can be a fluid or part of a fluid that is introduced into the well, for example, a drilling fluid, or a reservoir fluid or part of a reservoir fluid. The liquid hydrocarbon can be for example, crude oil, a saturated hydrocarbon, an unsaturated hydrocarbon, a branched hydrocarbon, a cyclic hydrocarbon, aromatic hydrocarbons, and combinations thereof.

The surfactant can be in a concentration of at least 0.1% by volume of the water. The surfactant can also be in a concentration in the range of about 0.1% to about 10% by volume of the water, preferably about 1% to about 6% by volume. According to an embodiment, the surfactant is in a sufficient concentration such that the liquid hydrocarbon becomes soluble in the treatment fluid.

The treatment fluid can further include additional additives including, but not limited to, pH buffers, viscosifiers, emulsifiers, weighting agents, fluid loss additives, friction reducers, surface wetting agents, scale inhibitors, catalysts, clay stabilizers, gases, foaming agents, and iron control agents.

The viscosifier can be selected from the group consisting of cellulose, polyacrylamides, guars, guar derivatives, xanthan, diutan, and combinations thereof. The viscosifier can be in a concentration in the range of about 10 to about 100 pounds per 1,000 gallons of the water.

The methods include the step of forming the treatment fluid. The treatment fluid can be formed ahead of use or on the fly. The methods include the step of introducing the treatment fluid into the well. The step of introducing can comprise pumping the treatment fluid into the well. The well can be, without limitation, an oil, gas, or water production well, an injection well, or a geothermal well. According to an embodiment, the well penetrates a reservoir or is located adjacent to a reservoir. The well can also be an offshore well.

The treatment fluid comes in contact with the wellbore particles after introduction into the well. For example, the treatment fluid can be pumped into a wellbore and after the fluid is located within the wellbore, the fluid can come in contact with the wellbore particles. At least a portion of the wellbore particles are coated with the liquid hydrocarbon prior to contact with the treatment fluid. Accordingly, after contact with the treatment fluid, the liquid hydrocarbon is removed from the portion of, preferably a majority of, and more preferably all of the wellbore particles. In this manner, the wellbore particles are cleaned of the liquid hydrocarbon or “preconditioned” to receive a resin or other surface coating/reactive type treatment. The removal of the liquid hydrocarbon from the wellbore particles is due to the surfactant solubilizing the liquid hydrocarbon into the treatment fluid. According to an embodiment, the wellbore particles are capable of bonding with a resin or other surface coating/reactive type treatment after the liquid hydrocarbon is removed from the wellbore particles.

According to an embodiment, the treatment fluid contacts the wellbore particles for a desired amount of time. The desired amount of time can be the time necessary for the liquid hydrocarbon to become soluble in the treatment fluid. The desired amount of time can also be the time necessary for the liquid hydrocarbon to be removed from the portion of, a majority of, or all of the wellbore particles. As mentioned previously, the treatment fluid can include a viscosifier and/or a foaming agent. These additional additives can help ensure that the treatment fluid remains in contact with the wellbore particles for the desired amount of time.

The methods can further include the step of removing at least a portion of the treatment fluid after the step of introducing. The treatment fluid that is removed can include the solubilized liquid hydrocarbon. The methods can further include introducing a resin or other surface coating/reactive type fluid into the well after the step of introducing the treatment fluid. The resin or coating can bind at least the portion of the wellbore particles together. The bound particles can form a consolidated particle pack. The resin can be a curable resin. The methods can further include causing or allowing the curable resin to cure. The methods can also further include introducing an acidizing fluid into the well after the step of introducing the treatment fluid. This embodiment can be useful when the treatment fluid is used to clean up and prepare the wellbore particles for an acidizing stimulation treatment.

According to another embodiment, a method of cleaning wellbore particles comprises: removing wellbore particles from a wellbore, wherein at least some of the wellbore particles are coated with a liquid hydrocarbon; and contacting the coated wellbore particles with the treatment fluid. This embodiment can be useful for preparing wellbore particles for disposal or storage. For example, the wellbore particles that are removed from the wellbore can be coated with the liquid hydrocarbon, which can cause problems for disposing of or storing the coated particles. The removed wellbore particles can be placed into a container, wherein the coated particles can then be contacted with the treatment fluid. Preferably, the removed and coated wellbore particles are allowed to remain in contact with the treatment fluid such that the liquid hydrocarbon solubilizes in the treatment fluid. The methods can further include disposing of, transporting, and/or storing the removed wellbore particles after cleaning.

### EXAMPLES

To facilitate a better understanding of the present invention, the following examples of certain aspects of preferred embodiments are given. The following examples are not the only examples that could be given according to the present invention and are not intended to limit the scope of the invention.

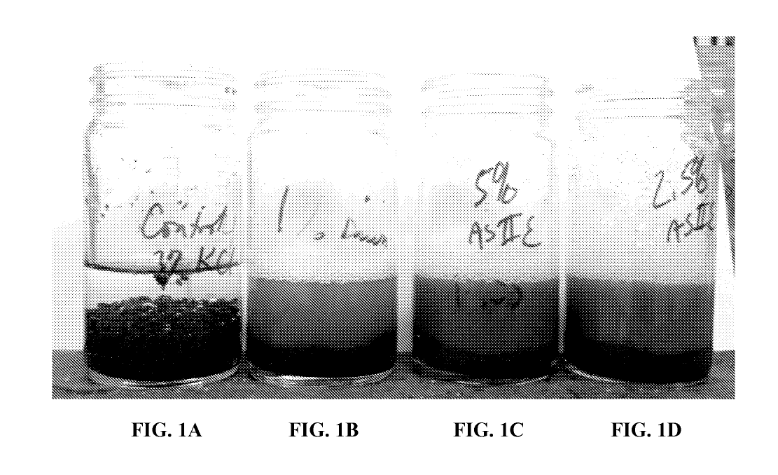

FIGS. 1A-1D are photographs of four different treatment fluids. Each of the jars contained 20 grams (g) of a subterranean formation sand that was coated with crude oil and a treatment fluid. The control treatment fluid (FIG. 1A) contained 40 milliliters (mL) of a 3% potassium chloride (KCl) salt and water solution. Treatment fluid B (FIG. 1B) contained 40 mL of the 3% KCl solution and 1% by volume DAWN® dishwashing detergent as the surfactant. Treatment fluid C (FIG. 1C) contained 40 mL of the 3% KCl solution and 5% by volume of a cationic alkylamine surfactant; whereas treatment fluid D (FIG. 1D) contained the cationic alkylamine surfactant at a concentration of 2.5% by volume.

As can be seen in the Figures, the control treatment fluid (FIG. 1A) did not contain any solubilized crude oil as evident from the clear liquid on top of the formation sand. However, the treatment fluids that contained a surfactant (FIGS. 1B-1D) solubilized the crude oil. As can also be seen, the concentration of the surfactant can vary and even low concentrations work effectively to solubilize the crude oil.

The exemplary fluids and additives disclosed herein may directly or indirectly affect one or more components or pieces of equipment associated with the preparation, delivery, recapture, recycling, reuse, and/or disposal of the disclosed fluids and additives. For example, the disclosed fluids and additives may directly or indirectly affect one or more mixers, related mixing equipment, mud pits, storage facilities or units, fluid separators, heat exchangers, sensors, gauges, pumps, compressors, and the like used generate, store, monitor, regulate, and/or recondition the exemplary fluids and additives. The disclosed fluids and additives may also directly or indirectly affect any transport or delivery equipment used to convey the fluids and additives to a well site or downhole such as, for example, any transport vessels, conduits, pipelines, trucks, tubulars, and/or pipes used to fluidically move the fluids and additives from one location to another, any pumps, compressors, or motors (e.g., topside or downhole) used to drive the fluids and additives into motion, any valves or related joints used to regulate the pressure or flow rate of the fluids, and any sensors (i.e., pressure and temperature), gauges, and/or combinations thereof, and the like. The disclosed fluids and additives may also directly or indirectly affect the various downhole equipment and tools that may come into contact with the fluids and additives such as, but not limited to, drill string, coiled tubing, drill pipe, drill collars, mud motors, downhole motors and/or pumps, floats, MWD/LWD tools and related telemetry equipment, drill bits (including roller cone, PDC, natural diamond, hole openers, reamers, and coring bits), sensors or distributed sensors, downhole heat exchangers, valves and corresponding actuation devices, tool seals, packers and other wellbore isolation devices or components, and the like.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is, therefore, evident that the particular illustrative embodiments disclosed above may be altered or modified and all such variations are considered within the scope and spirit of the present invention. While compositions and methods are described in terms of “comprising,” “containing,” or “including” various components or steps, the compositions and methods also can “consist essentially of” or “consist of” the various components and steps. Whenever a numerical range with a lower limit and an upper limit is disclosed, any number and any included range falling within the range is specifically disclosed. In particular, every range of values (of the form, “from about a to about b,” or, equivalently, “from approximately a to b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an”, as used in the claims, are defined herein to mean one or more than one of the element that it introduces. If there is any conflict in the usages of a word or term in this specification and one or more patent(s) or other documents that may be incorporated herein by reference, the definitions that are consistent with this specification should be adopted.

What is claimed is:

1. A method of treating a portion of a well comprising:
forming a treatment fluid, wherein the treatment fluid comprises:
(A) water; and
(B) a surfactant, wherein the surfactant is environmentally-friendly, and wherein the surfactant causes a liquid hydrocarbon to become soluble in the treatment fluid; and
introducing the treatment fluid into the well, wherein the treatment fluid comes in contact with wellbore particles after introduction into the well, wherein at least a portion of the wellbore particles are coated with the liquid hydrocarbon prior to contact with the treatment fluid.

2. The method according to claim 1, wherein the water is selected from the group consisting of freshwater, seawater, brine, produced water, and any combination thereof in any proportion.

3. The method according to claim 1, wherein the treatment fluid further comprises a water-soluble salt, wherein the salt is selected from the group consisting of sodium chloride, calcium chloride, calcium bromide, potassium chloride, potassium bromide, magnesium chloride, and any combination thereof.

4. The method according to claim 3, wherein the salt in a concentration in the range of about 1% to about 35% by weight of the water.

5. The method according to claim 1, wherein the surfactant is an ionic surfactant, nonionic surfactant, or a combination of ionic and nonionic surfactants.

6. The method according to claim 5, wherein the ionic surfactant is cationic, anionic, zwitterionic, or combinations thereof.

7. The method according to claim 6, wherein the ionic surfactant is selected from the group consisting of sodium oleate, sodium stearate, sodium dodecylbenzenesulfonate, sodium myristate, sodium laurate, sodium decanoate, sodium caprylate, sodium cetyl sulfate, sodium myristyl sulfate, sodium lauryl sulfate, sodium decyl sulfate, sodium octyl sulfate, derivatives of any of the foregoing, and combinations thereof.

8. The method according to claim 5, wherein the nonionic surfactant is selected from the group consisting of ethoxylated aliphatic alcohols, nonylphenol ethoxylates (NPEs), octylphenol ethoxylates (OPEs), sulfoxide esters, polyoxyethylene, carboxylic esters, polyethylene glycol esters, anhydrosorbitol ester and ethoxylated derivatives, glycol esters of fatty acids, carboxylic amides, monoalkanolamine condensates, polyoxyethylene fatty acid amides, branched alkylphenol alkoxylates, linear alkylphenol alkoxylates, branched alkyl alkoxylates, derivatives of any of the foregoing, and combinations thereof.

9. The method according to claim 1, wherein the hydrophobic tail of the surfactant has a carbon chain length such that the liquid hydrocarbon becomes soluble in the treatment fluid.

10. The method according to claim 1, wherein the wellbore particles are selected from the group consisting of proppant, gravel, subterranean formation sand and/or fines, and combinations thereof.

11. The method according to claim 1, wherein the liquid hydrocarbon is selected from the group consisting of crude oil, a saturated hydrocarbon, an unsaturated hydrocarbon, a branched hydrocarbon, a cyclic hydrocarbon, aromatic hydrocarbons, and combinations thereof.

12. The method according to claim 1, wherein the surfactant is in a concentration in the range of about 0.1% to about 10% by volume of the water.

13. The method according to claim 1, wherein the treatment fluid further comprises at least one additional additive, wherein the additional additives are pH buffers, viscosifiers, emulsifiers, weighting agents, fluid loss additives, friction reducers, surface wetting agents, scale inhibitors, catalysts, clay stabilizers, gases, foaming agents, and iron control agents.

14. The method according to claim 1, wherein the well is an oil, gas, or water production well, an injection well, or a geothermal well.

15. The method according to claim 1, wherein after contact with the treatment fluid, the liquid hydrocarbon is removed from the portion of the wellbore particles.

16. The method according to claim 15, wherein the wellbore particles are capable of bonding with a resin after the liquid hydrocarbon is removed from the wellbore particles.

17. The method according to claim 1, wherein the treatment fluid contacts the wellbore particles for a desired amount of time.

18. The method according to claim 17, wherein the desired amount of time is the time necessary for the liquid hydrocarbon to become soluble in the treatment fluid.

19. The method according to claim 1, further comprising removing at least a portion of the treatment fluid after the step of introducing, wherein the treatment fluid that is removed includes the solubilized liquid hydrocarbon.

20. The method according to claim 1, further comprising introducing a resin into the well after the step of introducing the treatment fluid.

21. The method according to claim 20, wherein the resin binds at least the portion of the wellbore particles together, wherein the bound particles form a consolidated particle pack.

22. A method of cleaning wellbore particles comprising:
removing wellbore particles from a wellbore, wherein at least some of the wellbore particles are coated with a liquid hydrocarbon; and
contacting the coated wellbore particles with a treatment fluid, wherein the treatment fluid comprises:
(A) water; and
(B) a surfactant, wherein the surfactant is environmentally-friendly, and wherein the surfactant causes the liquid hydrocarbon to become soluble in the treatment fluid.
